(19) United States
(12) Patent Application Publication
(10) Pub. No.: US 2015/0233418 A1
(43) Pub. Date: Aug. 20, 2015

(54) BEARING HAVING AN INDICATOR

(71) Applicant: SCHAEFFLER TECHNOLOGIES AG & CO. KG, Herzogenaurach (DE)

(72) Inventors: Horst Brehm, Bischberg (DE); Daniel Callies, Nordhausen (DE)

(73) Assignee: SCHAEFFLER TECHNOLOGIES AG & CO. KG, Herzogenaurach (DE)

(21) Appl. No.: 14/428,828

(22) PCT Filed: Aug. 6, 2013
(86) PCT No.: PCT/DE2013/200102

§ 371 Date: Mar. 17, 2015

(30) Foreign Application Priority Data
Sep. 19, 2012 (DE) 10 2012 216 762.5

(51) Int. Cl. F16C 19/52; F16C 41/00

(52) U.S. Cl. CPC F16C 19/52; F16C 41/00

(57) ABSTRACT

Bearing, in particular rolling bearing, including, as bearing parts, at least one bearing ring (1, 2), a sealing element or a cage (3). The object of providing a bearing which can easily be retrofitted for subsequent damage analysis and does not necessitate any significant design modifications compared to standard bearings is achieved, according to the invention, for the bearing mentioned in the introduction by an indicator (4, 5, 6, 7) which can be triggered mechanically, in particular by impact and/or mechanical tensile or compressive stress, being arranged on the surface of the body of the bearing part and, when a limit value is reached, has an irreversible, visually ascertainable change.

### BACKGROUND

### Field of the Invention

The invention relates to a bearing, in particular an anti-friction bearing, comprising at least one bearing ring, a sealing element or, if the bearing is configured as an anti-friction bearing, a cage as bearing parts.

Bearings of this type are designed and installed for the rotatable and/or displaceable mounting of components. If the bearing fails, it remains to test and possibly prove whether the damage is to be attributed to the fact that the bearing had been installed in a way for which it was not designed. To this end, the mechanical forces or stresses which have acted on the bearing during operation are to be detected and verified.

The operating state of the bearing, even in the installation position, can be monitored by means of electronic sensors, for example by means of piezoelectric pressure sensors or strain gauges, but sensors of this type which supply a continuous electrical signal are complicated and cannot be installed without redesign of the bearing.

### SUMMARY

It is the object of the invention to specify a bearing which can be retrofitted simply for retroactive damage analysis and does not make any substantial structural modifications in comparison with standard bearings necessary.

According to the invention, this object is achieved for the bearing which was mentioned at the outset by way of an indicator which can be triggered mechanically, in particular by jolting and/or mechanical tensile or compressive stress, is arranged on the surface of the body of the bearing part and, when a limit value is reached, has an irreversible change which can be detected visually.

The indicator shows whether the bearing was subjected during operation to a predefined load above the structurally induced limit value or not, with the result that said overloading can be determined as a possible cause of damage.

The indicator can be attached easily, without it being necessary for the bearing to be modified structurally. Suitable indicators are known in principle from the field of packaging, in particular as ShockWatch indicators or as cracking varnish, and can be used for a modified purpose in bearings.

It is preferably provided that the indicator comprises a cracking varnish. The cracking varnish which is applied to the surface of the body of the bearing part shows linear cracks which occur transversely with respect to a tensile loading direction and can be detected visually by way of simple observation, and not only makes it possible to qualitatively determine whether a mechanical stress has been reached or exceeded, but rather likewise makes it possible to detect the load direction, along which the impermissible mechanical stress has acted.

It is preferably provided that the indicator undergoes a color change when the limit value is reached.

In particular, it is preferably provided that the indicator comprises a closed volume of a test liquid, in particular in a glass tube. Indicators of this type are known in principle as ShockWatch indicators and are based on the principle that a jolt ruptures the surface tension of the test liquid, with the result that the test liquid changes its color. Indicators of this type can be used as jolt indicators in bearings or as an indicator that a permissible limit rotational speed has been exceeded.

It is preferably provided that the indicator comprises a test film. The test film comprises a material which carries out a color change when the limit value is reached, with the result that, in particular, mechanical stresses can be verified, specifically on anti-friction bearing cages which are composed of a ductile material.

Further advantages and features of the invention result from the dependent claims and from the description of one exemplary embodiment.

In the following text, the invention will be described and explained in greater detail with reference to the appended drawing.

### BRIEF DESCRIPTION OF THE DRAWINGS

FIG. 1 shows a plan view of one exemplary embodiment of a bearing according to the invention.

### DETAILED DESCRIPTION OF THE PREFERRED EMBODIMENTS

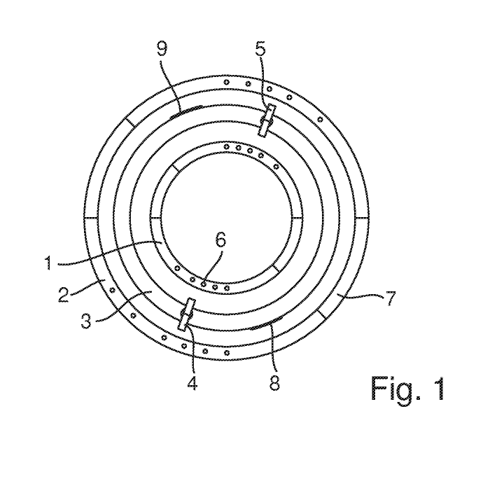

FIG. 1 shows a bearing which is configured as an anti-friction bearing, comprising, as bearing parts, a first bearing ring 1 which is configured as an inner ring, a second bearing ring 2 which is configured as an outer ring, a cage 3 for guiding rolling bodies (not shown), and, as further bearing part, a bearing seal (not shown).

A ShockWatch indicator is arranged as first indicator 4 on the end face of the body of the cage 3, in order to detect forces which act radially in relation to the rotational axis of the bearing, occur in a jolt-like manner and reach a limit value, with the result that the first indicator 4 carries out a color change which can be detected visually. The first indicator 4 comprises a closed volume of a test liquid in a glass tube, the surface tension of the test liquid being ruptured when the limit value is reached, and the test liquid carrying out an irreversible color change.

Lying radially opposite the first indicator 4 in relation to the rotational axis, a second indicator 5 is arranged on the end face of the body of the cage 3, which second indicator 5 comprises a test film which carries out an irreversible color change, which can be detected visually, as a result of mechanical stresses if the latter reach a limit value. The second indicator 5 is arranged such that it is directed radially, that is to say in the direction of the centrifugal forces, but might also be arranged in the circumferential direction of the cage 3 in one modification of the exemplary embodiment which is shown, since the material stresses also occur in the cage 3 in the circumferential direction.

In each case one section is provided with a cracking varnish on the end face both of the first bearing ring 1 and of the second bearing ring 2, one of the four sections being denoted by the designation “6” and forming a third indicator 6. Under mechanical tensile stresses, the cracking varnish forms irreversible cracking lines which can be detected visually, in particular transversely with respect to the direction of the tensile stresses.

In each case one circular segment-shaped section of a pressure measuring film is arranged centrally in the circumferential direction between in each case two cracking varnish sections both of the first bearing ring 1 and of the second bearing ring 2, of which circular segment-shaped sections one is denoted by the designation “7” and forms the fourth indicator 7. In the case of mechanical loading, irreversible mechanical changes which can be detected visually, for example, by means of polarized light are caused in the pressure measuring film of the fourth indicator 7.

Furthermore, the bearing comprises at least two temperature indicators 8, 9 which are arranged on the cage 3, so as to lie radially opposite one another in relation to the rotational axis, on the circumferential face, so as to adjoin the end face of the cage 3, and carry out an irreversible color change which can be detected visually when a critical temperature is reached.

Furthermore, the bearing comprises a moisture indicator (not shown in the FIGURE) which carries out an irreversible color change which can be detected visually when a critical humidity is reached in the bearing; this moisture indicator is arranged, for example, on the inner circumferential face of the second bearing ring 2 or on the outer circumferential face of the first bearing ring 1, close to the end face of the respective bearing ring 1, 2, in order to make it easy to read the color of the moisture indicator.

### LIST OF DESIGNATIONS

1 First bearing ring
2 Second bearing ring
3 Cage
4 First indicator
5 Second indicator
6 Third indicator
7 Fourth indicator
8 Temperature indicator
9 Temperature indicator

1. A bearing, comprising at least one bearing ring, a sealing element or a cage, and an indicator which is triggered mechanically by at least one of jolting, mechanical tensile stress, or compressive stress, arranged on a surface of the at least one bearing ring, the sealing element, or the cage and, when a limit value is reached, has an irreversible change which is detectable visually.

2. The bearing as claimed in claim 1, wherein the indicator carries out a color change when the limit value is reached.

3. The bearing as claimed in claim 1, wherein the indicator comprises a closed volume of a test liquid.

4. The bearing as claimed in claim 1, wherein the indicator comprises a test film.

5. The bearing as claimed in claim 1, wherein the indicator comprises a pressure measuring film.

6. The bearing as claimed in claim 1, further comprising a temperature indicator which, when a critical temperature is reached, carries out a color change which is detected visually.

7. The bearing as claimed in claim 1, wherein the indicator comprises a cracking varnish.

8. The bearing as claimed in claim 3, wherein the test liquid is in a glass tube.
